(19) United States
(12) Patent Application Publication
(10) Pub. No.: US 2002/0087470 A1
(43) Pub. Date: Jul. 4, 2002

(54) Configurable billing system supporting multiple printer products and billing strategies

(75) Inventors: Katherine E. Hayes, Rochester, NY (US); Mark A. Smith, Rochester, NY (US); Jay Glaspy, Rochester, NY (US)

Correspondence Address: Albert P. Sharpe, III, Esq., Fay, Sharpe, Fagan, Minnich & McKee, LLP, 7th Floor, 1100 Superior Avenue, Cleveland, OH, 44114-2518, US

(73) Assignee: XEROX CORPORATION

(21) Appl. No.: 09/750,603

(22) Filed: Dec. 28, 2000

(51) Int. Cl. G06F 17/60

(52) U.S. Cl. 705/40

(57) ABSTRACT

A billing module for a document processing system is configured by the document processing system. The billing module accepts a billing strategy from the document processing system. The billing strategy lists parameters or events the billing module is to monitor. Additionally the billing strategy provides algorithms. The algorithms define the function of billing meters. The billing module instantiates meters according to the strategy and updates the meters based on the monitored parameters as described by the billing strategy. The billing module is used by a wide variety of devices. Device developers need only define the billing strategy, in for example a billing strategy script. The need to “hard code” custom billing software for each new device is eliminated. Instead the billing module is reused and simply reconfigured via the billing strategy script.

### BACKGROUND OF THE INVENTION

1. Field of the Invention

The invention relates to the art of configurable billing systems. The invention finds application in document processing equipment and will be described in reference thereto. However, the invention can be applied wherever a product or service is performed through the use of a machine. The invention is particularly applicable where the product or service can be delivered with a wide variety of optionally purchased aspects or features.

2. Description of Related Art

The demands of the marketplace have and will continue to drive the development and proliferation of a wide variety of document processing equipment. Traditionally, when an untapped and profitable market segment is discovered, a development effort produces a new document processing system that is custom designed to meet the needs of the newly discovered market segment. The custom design has typically included the use of new or customized components, such as, for example, sensors, actuators, and user interfaces, as well as new software. The new or custom components are selected based on cost versus performance requirements of the market segment. The appropriate new software is written to accommodate features of the new components. Such development projects have even included the re-writing of billing or metering software. This has been necessary since different devices or market segments require different billing strategies.

For example, in markets where customers object to being billed for diagnostic document processing, features have evolved that allow diagnostic document production runs to be identified and omitted from a customer's bill. For example, some document processing systems include shadow meters. Shadow meters record the same kinds of events that are recorded by standard meters. However, shadow meters record the events, for example, only during diagnostic document production runs. The values stored in the shadow meters are subtracted from the values stored in the standard meters before a customer's bill is generated. Other devices use diagnostic flags. Diagnostic flags indicate, for example, that standard meters should not be updated, since the current processing is related to the diagnostic activities of a service technician. Diagnostic flag operation requires less system memory. Therefore, it is the technique of choice in cost sensitive designs. However, diagnostic flag operation has a drawback. In diagnostic flag operation, system wear information is lost. The system “mileage” that accrues during diagnostic procedures is not recorded when diagnostic flags are used to stop the “odometers”. Therefore, the use of diagnostic flags can have detrimental effects on, for example, preventive maintenance scheduling.

In some markets, customers expect a discount for large production runs. Therefore, some document processing systems include meters that record impressions that are to be discounted. For example, a discount impression meter is incremented only if five hundred or more impressions have been made before the current impression.

Some products can serve several markets. However, because of different market pressures in the several markets, the machines must be configured to bill differently in each of the several markets. Where billing software is “hard coded” into the image processor, adapting machines to these various markets is problematic. Each software version must be written, tested and maintained separately. On the other hand, if a problem is discovered in one version, all the other versions must be checked in order to determine if the problem is common to all versions or limited to only one version. In short, hard coded billing software is expensive and inflexible.

Still other products have evolved to provide some meters that are resettable, while maintaining others to be secure and guaranteed not to be resettable.

As each new image processor has been developed, it has been deemed reasonable or expedient to develop new billing software along with the new document processing system, in order to provide required new features or new combinations of features. One reason for this is that there has been no easy to use alternative.

The high cost of product development and market pressures for fast design turn around have lead to a desire for modular designs. Modular designs allow new products to be created by re-configuring and rearranging available components and sub-assemblies. Software, including billing software, represents a time consuming and expensive aspect of new product development. Therefore, there are strong market pressures to reuse previously developed software. However, it has been difficult to write software that can be reused in future designs when the features and requirements of future designs are unknown.

### BRIEF SUMMARY OF THE INVENTION

The present invention is a solution to the design for reuse problem in general, and for billing software reuse in particular.

In one aspect of the present invention, a configurable billing system for a machine is provided, the machine being operative to output a product or service. The machine comprises a plurality of aspect sensors. The sensors detect the delivery of aspects of the product or service and report the delivery to the billing system. The billing system operates to tally aspects of the output of the machine. The billing system comprises a coded billing strategy delivered by the machine to the billing system, and a plurality of meters updated by the billing system for recording the delivery of the aspects of the product or service in a manner described by the billing strategy.

One embodiment of the present invention comprises a configurable billing system for a document processing system, where the document processing system operates to produce documents. The document processing system comprises a plurality of aspect sensors operative to detect document production events and to report aspects of document production to the billing system. The billing system operates to record the reported aspects. The aspects are recorded, for example, in order to calculate charges for a bill of a customer. The billing system comprises a billing strategy description delivered by the document processing system to the billing system, a plurality of meters, and a billing module operative to update the plurality of meters according to the billing strategy.

Another aspect of the invention comprises a method for developing and using a universal billing module. In some embodiments the method comprises predefining a billing strategy, wherein the billing strategy includes a list of parameters and process algorithm information, and storing the billing strategy in a machine-readable form. Preferably, the list of parameters includes implicit or explicit communication mechanisms, and data parsing information.

One advantage of the present invention is found in a reduction in time to market the invention provides new product developments.

Another advantage of the present invention is that custom billing module functionality is provided through the relatively simple generation of a billing strategy.

Yet another advantage of the present invention resides in the ability to easily change or update the functionality of a machine, either at the factory, to satisfy the needs of a new market, or in the field, to customize the machine for a new task.

Still other advantages of the present invention will become apparent to those skilled in the art upon a reading and understanding of the detail description below.

### BRIEF DESCRIPTION OF THE SEVERAL VIEWS OF THE DRAWINGS

The invention may take form in various components and arrangements of components, and in various steps and arrangements of steps. The drawings are only for purposes of illustrating preferred embodiments, they are not to scale, and are not to be construed as limiting the invention.

FIG. 1 is a block diagram of a first document processing system including a universal billing module;

FIG. 2 is a first billing strategy operative to configure the universal billing module to operate within the environment of the first document processing system;

FIG. 3 is a block diagram of a second document processing system including a universal billing module;

FIG. 4 is a second billing strategy operative to configure the universal billing module to operate within the environment of the second document processing system; and

FIG. 5 is a flow chart summarizing a method for developing and using a reusable billing module.

### DETAILED DESCRIPTION OF THE INVENTION

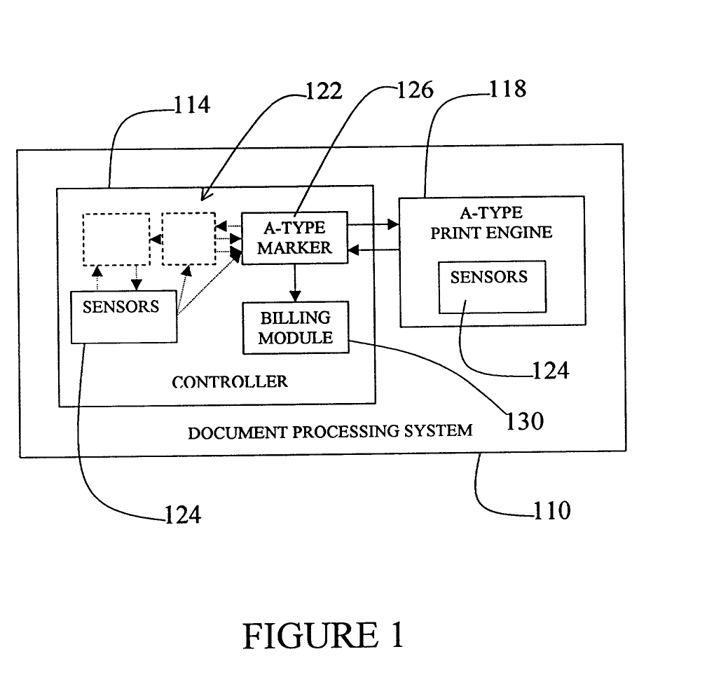

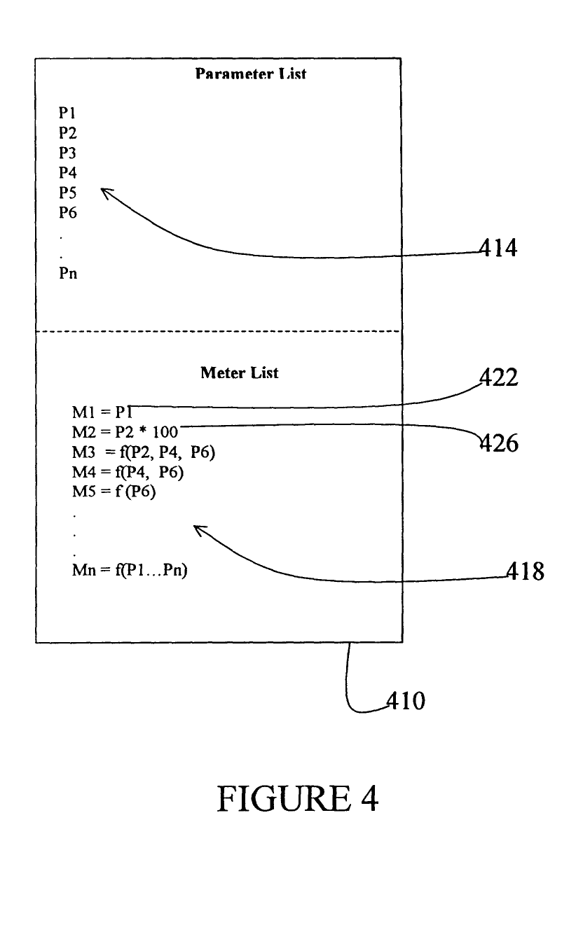

Referring now to the drawings wherein the showings are for purposes of illustrating the invention and not for purpose of limiting the same thereto, FIG. 1 is a block diagram of a first document processing system 110. The first document processing system 110 comprises a controller 114 and an A-type print engine 118. For example, the A-type print engine 118 is a XEROX DocuTech 6180 xerographic print engine. The controller 114 comprises hardware and software modules 122 for controlling and operating the document processing system 110. The modules 122 are in communication with sensors 124 directly or indirectly. For example, document processing system 110 may contain sensors 124. The sensors 124 can be real sensors distributed throughout the A-type print engine 118 and/or virtual sensors, distributed throughout software modules of the A-type print engine 118 (not shown) and/or controller 114. Sensors are discussed in greater detail in reference to FIG. 4 below. The modules include an A-type marker 126 module. The A-Type marker 126 is a module specifically designed for controlling and taking advantage of the features and capabilities of A-Type print engines 118. For example, the A-type marker 126 is a Xerox DocuTech 6180 marker module, designed to control and take advantage of features of a Xerox DocuTech 6180 print engine. The A-type marker 126 is in communication with a universal billing module 130. The billing module 130 may be part of the controller. Alternatively, the billing module 130 is separate from the document processing system 110 and simply in communication with the document processing system 110. For example, the billing module 130 may be in communication with the first document processing system 110 via a computer network.

The billing module 130 is a universal software module. The billing module 130 is universal in that it accepts configuration information and data from, for example, any marker module. Alternatively, a billing module may read this information directly from files and/or sensors. Therefore, the billing module 130 is able to record billable events and activities of any kind and in any combination. This universality is provided by the ability of the billing module to receive, decipher, and implement a billing strategy or set of billing instructions from another module or device. For example, the billing module 130 receives a strategy description from the A-type marker 126. The strategy is preferably stored in an available storage device of the controller 114. Alternatively, the strategy is read and accessed directly by the billing module 130.

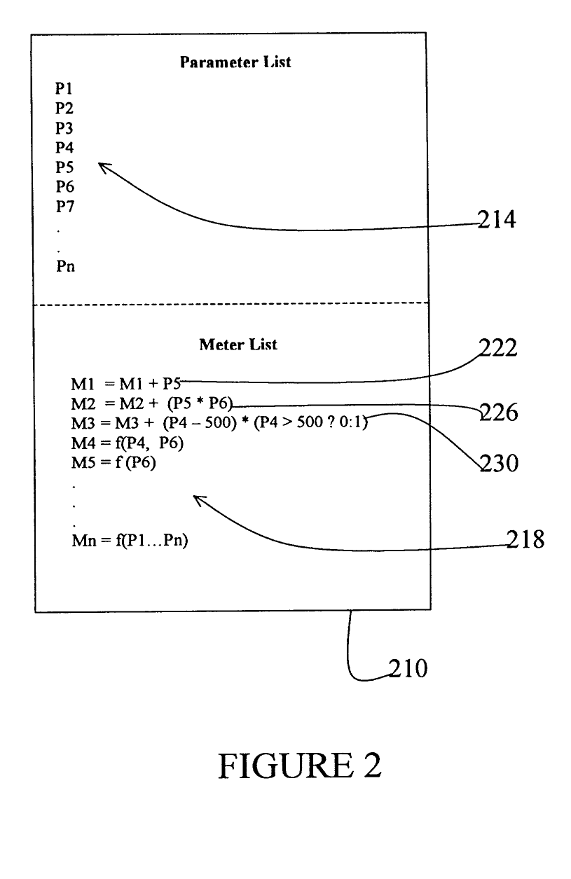

Referring to FIG. 2, a first billing strategy 210 comprises, for example, a list of parameters 214 or aspects of interest and a list of meter descriptions 218.

The parameter list 214 is arbitrarily long and contains parameters, for example, P1 through Pn. The parameter list 214 informs the billing module 130 of the billable events or activities a marker module is capable of reporting. Furthermore, the parameter list 214 explains the format in which the marker 126 will communicate the parameters to the billing module. For example, the parameter list includes an impression flag. Alternatively or additionally, the parameter list may include a count of total impressions made parameter. An impressions flag is used to indicate that the marker 126 has issued commands to the print engine 118 causing the print engine to print an image on, for example, one side of a piece of paper (an impression on the other side of the piece of paper counting as a second impression). A count of total impressions made is, for example, a grand total of impressions made during a particular print job.

Other parameters types that may be included in a parameter or aspect list include a set completion flag, a set count, a diagnostic impression flag, a media descriptor, a highlight color flag and a full color flag. A set is some logical grouping of document pages. For example, a set is a collection of document pages on which a finishing step is performed. For instance, a set is a group of pages that are stapled together. Alternatively, a set is, for example, a collection of stapled documents that are shrink-wrapped together. A set completion flag indicates the completion of a set. Alternatively, a set completion flag indicates the completion of a number of sets. For example, a set completion flag may indicate the completion of ten or one hundred sets. A set count is, for example a running total of completed sets. Alternatively a set count is a grand total of sets completed in a job. A diagnostic impression flag indicates, for example, that an impression is a diagnostic impression, ordered, for example, by a service technician. In some cases, customers are not charged for diagnostic impressions. A diagnostic set flag may be used to indicate that a set is being run for diagnostic purposes. A media descriptor indicates, for example, the kind of media an impression is made on. For example, a media descriptor indicates that large paper is used or that a sheet of velum is marked or that regular paper is being printed on. A highlight color flag indicates when highlight color is included in an impression. A full color flag indicates when an impression includes full color markings. This list is exemplary only, and not intended to be limiting. Indeed, an important aspect of the billing module 130 is that the billing module 130 is readily adapted to record and use information regarding billable aspects of document processing that have not as yet been conceived.

A communications protocol may be implicit in the architecture of the billing module 130. For example, it may be understood that each parameter or aspect in a parameter list will be communicated to the billing module in, for example, an eight-bit word. However, preferably, the format that the parameters are communicated to the billing module in is included in the parameter list. For example, a parameter or aspect list includes a first flag that is one bit long, a first count that is sixteen bits long, a second count that is eight bits long and a second flag that is one bit long. Having the data format passed to the billing module 130 by the marker is preferable because it provides for increased universality, especially with regard to as yet undeveloped markers and print engines.

The meter description 218 portion of the strategy specification 210 is also arbitrarily long and contains, for example, meter descriptions M1 through Mn. In general, the meter descriptions are expressed in the form of functions f( ) of the parameters P1 through Pn. The meter descriptions 218 explain what the billing module 130 is to do with parameter or aspect information passed to it. For example, the billing module 130 is instructed to maintain a first meter M1. An equation or function describes the operation of the first meter. For, example first expression 222:

M1=M1+P5

describes the function of the first meter M1. For instance, parameter P5 is an impression count. Parameter P5 reports the number of impressions made in a set upon the completion of the set. Therefore, when updated, the first meter M1 records a total number of impressions made. The updated value of the first meter M1 is the old value contained in the first meter M1 plus the number of impressions P5 made in the set.

Additionally, the billing module is instructed to maintain a second meter M2. The second meter M2 is defined by a second expression 226:

M2=M2+(P5*P6)

Parameter P6 is a diagnostic flag. For example, parameter P6 is one bit long and therefore has a value of zero or one. When parameter P6 has a value of zero, the second expression 226 or meter M2 operates to maintain the value of the second meter M2. That is to say, the new value of the second meter M2 is equal to the old value of the second meter M2 (M2=M2). When the diagnostic flag P6 has a value of one, the second meter M2 operates to add the number of impressions made during the creation of a set, to the old total number of impressions (M2=M2+P5).

The meter list section 218 of the first strategy specification 210 also operates to instruct the billing module 130 to keep track of discounted impressions with a third expression 230:

M3=M3+(P4−500)*(P4>500 ?0:1)

Parameter P4 is, for example, a set count. The set count is a running total of the number of sets completed during a job. When the inequality (P4>500) within the third expression is false, the right hand parenthetical expression (P4>500 ?0:1) has a value of zero. When the inequality is true the right hand parenthetical expression of the third expression 230 has a value of 1. Therefore, while parameter P4 is not greater than five hundred, the third meter M3 or expression 230 operates to maintain the value of the third meter (M3=M3). When the set count P4 in a job exceeds five hundred, the third meter M3 or operates to tally the number of sets in the job, beyond the five hundredth set (M3=M3+(P4−500)).

Preferably, the meters described in the meter list 218 are implemented as virtual meters comprising memory locations that are written and read from as required. However, real meters can also be used. Where real meters are used, the billing module controls signaling hardware that increments or updates the meters as required. Of course, the values in virtual meters are read and displayed or communicated to other devices as desired.

As can be seen from the above description, a system developer can implement the billing portion of an image processor by including a copy of the universal billing module 130 in the system or by providing communications means between the system and a billing module 130. The only other significant development work required is the creation of a billing strategy. The billing strategy may be hard coded and stored along with the system software or it maybe stored separately and accessed when needed. For example the strategy maybe stored as a file on a disk. Preferably, the strategy is secured by some protection technology such as password protection and/or encryption. Typically, a billing strategy is delivered to a billing module when a document processing system is first commissioned. Additionally, an updated strategy is delivered to a billing module when the document processing system is reconfigured. Alternatively, a billing strategy is delivered to a billing module at every system power up. Additionally, billing strategies may be delivered or updated remotely. For example, an image processor is connected to a computer network or includes a telephone modem. A billing strategy is downloaded to the image processor over these computer communication links.

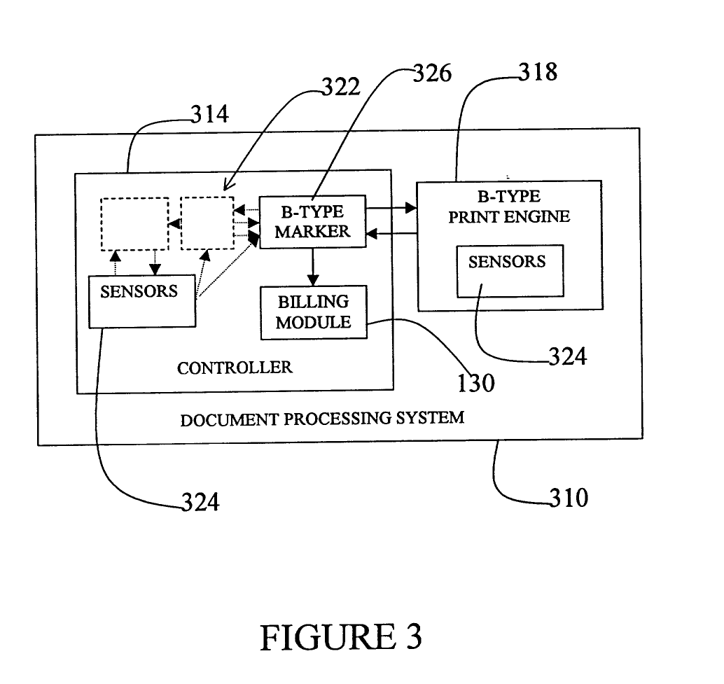

To further illustrate this, FIG. 3 is a block diagram of a second document processing system 310. The second document processing system comprises a controller 314 and an B-type print engine 318. For example, the B-type print engine 318 is a XEROX DocuColor 2060 xerographic print engine. The controller 314 comprises hardware and software modules 322 operative to control and operate the document processing system 310. The modules are in communication with sensors 324 directly or indirectly. For example, the document processing system 310 may contain sensors 324. The sensors 324 can be real sensors distributed throughout the B-type print engine 318 and/or virtual sensors, distributed throughout software modules of the B-type print engine 318 (not shown) and/or controller 314. The modules 322 include a B-type marker 326 module. The B-Type marker is a module specifically designed for controlling and taking advantage of the features and capabilities of B-Type print engines. For example, the B-type marker 326 module is a Xerox DocuColor 2060 marker, designed to control and take advantage of features of a XEROX DocuColor 2060 print engine. The B-type marker 326 is in communication with a copy of the universal billing module 130. Just as described in reference to FIG. 1, the billing module 130 is part of the controller or the billing module 130 is separate from the document processing system 310 and simply in communication with the document processing system 310.

The billing module 130 of FIG. 3 is an identical copy of the billing module 130 of FIG. 1, and therefore, carries the same reference numeral. The billing module 130 is configured by the B-type marker 326 to record billing information in a manner that is convenient and complementary to the features and architecture of the B-type marker 326 and the B-type print engine 318. For example, the billing module 130 receives a strategy description from the B-type marker 326 (or from some other device, such as for example, a file (not shown).

Referring to FIG. 4, a B-type strategy 410 may be different than the A-type strategy 210. For example, the B-type strategy 410 comprises a list of parameters 414 or aspects of interest and a list 418 of meter descriptions that are different than the parameter list 214 and meter list 218 of the first or A-type strategy 210. The parameter list 414 informs the billing module 130 of the billable events or activities the B-type marker module 326 is capable of performing. Furthermore, the parameter list 414 explains the format in which the B-type marker 326 will communicate the parameters to the billing module 130.

The meter description 418 portion of the B-type strategy specification 410 explains what the billing module 130 is to do with the parameter or aspect information passed to it. For example, the billing module 130 is instructed to maintain a first meter M1. In the second document processing system 310, the processor keeps a running total of the number of impressions the processor makes. For example, hardware or software counters in the print engine keep track of the number of impressions. That total is passed to the billing module in a first parameter P1. The first meter M1 is configured to keep track of the total number of impressions the document processing system makes by simply updating M1 with the running total kept by the document processing system 310. For example, meter M1 of the second document processing system 310 is described by a first expression 422:

M1=P1

The B-type marker 326 also instructs the billing module 130 to keep track of the number of “3-pitch” sheets that are processed. A pitch is related to a sequence of events that comprise, for example, a xerographic printing process. For example, the sequence of steps required to infuse a sheet with one color toner can be classified a pitch. A 3-pitch sheet is a sheet that is processed through a basic sequence of steps three times. For example, a sheet longer than 9 inches is a 3-pitch sheet. An instruction to the billing module 130 to keep track of the number or 3-pitch sheets is, for example, found in a second expression 426:

M2=P2*100

wherein P2 reflects a marker 326 count of every hundredth 3-pitch sheet.

The information delivered to the billing module originates from sensors 124, 324 distributed throughout a document processing system. The sensors can be real sensors or virtual sensors. Real sensors are physical in nature and sense physical events. For example, an optical sensor reports the transfer of a sheet from a supply tray. A limit switch notes the passing of a sheet past a transfer point. A virtual sensor is embodied in software and notes the occurrence of a logical event. A virtual sensor can be active or passive. An active virtual sensor scans part of the system, for example, the active virtual sensor examines a memory or register location and tests to see if values stored there match an anticipated value. The active virtual sensor then reports whether or not a match is found. A passive virtual sensor is usually embodied as a memory or register location. System software reports system activity by writing status information to the passive virtual sensor. Software then reads information from the passive virtual sensor at an appropriate point in, for example, a document processing procedure. For example, the print engine reads a passive sensor and reports its output to the marker, which in turn reports the passive sensor output to a billing module 130. Alternatively, a billing module 130 reads the passive sensor directly.

Preferably, information reaches a billing module 130 as described, through services of a single software module, such as, for example a marker 126, 326. However, other architectures are possible. For example, networked system components may report information directly to the billing module 130. A networked output tray sensor may report the completion of a sheet or the completion of a set directly to a billing module 130. In such an architecture, the billing module may receive the billing strategy from one of the networked components, for example, a networked controller module. The billing strategy may further include, for example, a sensor introduction section, explaining the type and communication mechanism of various system sensors. Production event or aspect information is then delivered directly from the sensors (real and virtual) directly to the billing module via a network.

Billing information is, of course, sensitive by nature. Therefore, security measures can be included in the billing module and related systems. For example, the billing strategy is stored in an encrypted form. Access to the billing strategy is restricted. For example, a password is required to update or gain access to the billing strategy. Likewise, meters maintained by the billing module are protected against tampering. For example, virtual meter data is encrypted and stored in a non-volatile storage medium.

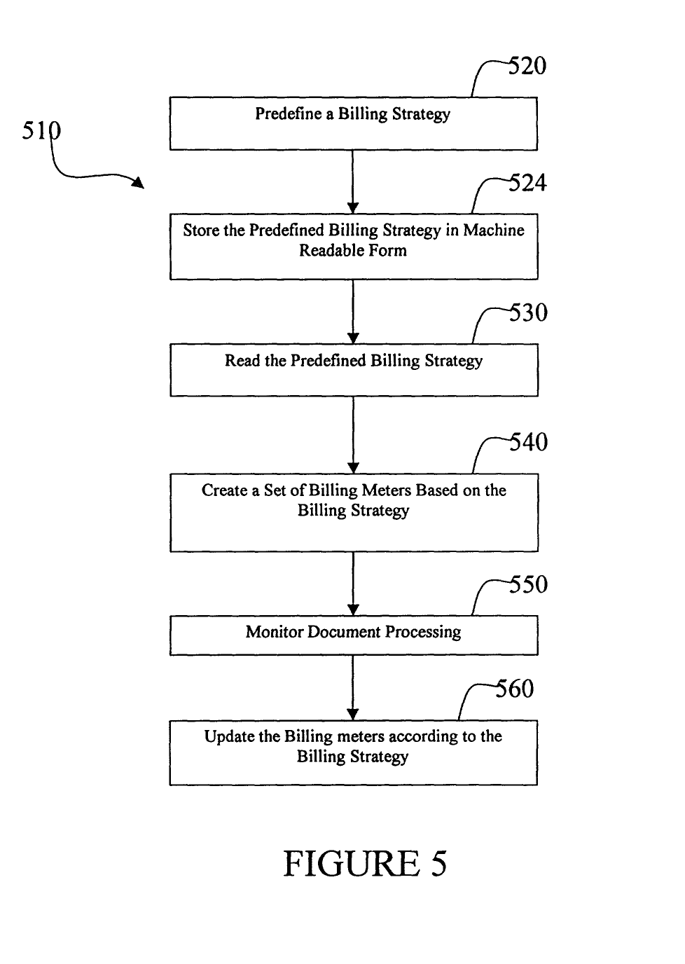

Referring to FIG. 5, a method 510 for developing and using a universal billing module comprises a billing strategy predefinition step 520. As described in reference to FIG. 2 and FIG. 4, a billing strategy includes a parameter list with implicit or explicit communication mechanisms and data parsing information. Additionally, the billing strategy includes processing algorithm information in the form of, for example, a machine-readable script. In a billing strategy-reading step 530, the billing strategy is read, for example, by a billing module. The billing strategy is decoded and followed. In a billing meter creation step 540, memory is allocated for the storage of “meter” type data structures and the meters are initialized or “zeroed out”. Of course, the billing meter creation step 540 is only carried out when a required meter does not already exist. In many cases meters are instantiated in non-volatile memory and persist even when the image processor is turned off. Typically, where a meter already exists, the meter is not initialized or zeroed out. In a process-monitoring step 550, the universal billing module monitors document processing system operation. In a meter-updating step 560 the meters are updated, based on the monitored operations, as instructed by the billing strategy machine-readable script.

The invention has been described with reference to particular embodiments. Modifications and alterations will occur to others upon reading and understanding this specification. For example, while the invention has been describe in relations to a billing module in a document processing system the method for developing and using reusable code can be applied to the development and use of any functional block or module. Furthermore, the universal billing module 130 can be applied to any machine that renders a product or service. When the invention is applied to document processing system applications, the document processing systems need not include print engines or marking modules. For example, a stand alone finishing devices such as, for example, collators, staplers, and shrink wrappers can take advantage of the universal billing module 130. It is intended that all such modifications and alterations are included insofar as they come within the scope of the appended claims or equivalents thereof.

What is claimed is:

1. A configurable billing system for a machine, the machine operative to output a product or service and including a plurality of aspect sensors, the sensors operative detect the delivery of aspects of the product or service and to report the delivery to the billing system, the billing system comprising:
a coded billing strategy defined for the machine; and
a plurality of meters updated by the billing system for recording the delivery of the aspects of the product or service based on the billing strategy whereby the billing system tallies the aspects in a predefined manner.

2. The configurable billing system of claim 1 wherein the coded billing strategy comprises a list of aspects of interest.

3. The configurable billing system of claim 1 wherein the coded billing strategy comprises a list of meters.

4. The configurable billing system of claim 3 wherein the coded billing strategy comprises information associated with the listed meters, the information describing the function of the meters.

5. The configurable billing system of claim 1 wherein the coded billing strategy comprises information representing a set of functions describing the operation of a set of meters.

6. A configurable billing system for an document processing system, the document processing system operative to produce documents and including a plurality of aspect sensors operative to detect document production events and to report the aspects of the document production to the billing system, the billing system comprising:
a billing strategy description accessible by the billing system;
a plurality of meters defined in the billing strategy; and
a billing module operative to update the plurality of meters according to the billing strategy.

7. The configurable billing system of claim 6 wherein the billing strategy description comprises a list of aspects of interest.

8. The configurable billing system of claim 7 wherein the list of aspects of interest comprises an impression count.

9. The configurable billing system of claim 7 wherein the list of aspects of interest comprises an impression event flag.

10. The configurable billing system of claim 7 wherein the list of aspects of interest comprises set count.

11. The configurable billing system of claim 7 wherein the list of aspects of interest comprises a set completion flag.

12. The configurable billing system of claim 7 wherein the list of aspects of interest comprises a diagnostic impression flag.

13. The configurable billing system of claim 7 wherein the list of aspects of interest comprises a media descriptor.

14. The configurable billing system of claim 7 wherein the list of aspects of interest comprises a highlight color flag.

15. The configurable billing system of claim 7 wherein the list of aspects of interest comprises a full color flag.

16. A document processing system comprising:
a print engine;
a configurable billing system operative to follow a billing strategy and to record the occurrence of document production events described in the billing strategy;
a marker module operative to control the print engine in the production of documents, and to report document production events to the billing system.

17. The document processing system of claim 16 wherein the marker module is operative to deliver the billing strategy to the billing system.

18. The document processing system of claim 16 wherein the print engine further comprises a xerographic printer.

19. A method for developing and using a universal billing module, the method comprising:
predefining a billing strategy, the billing strategy including a list of parameters with implicit or explicit communication mechanisms and data parsing information, and process algorithm information; and
storing the billing strategy in a machine-readable form reading the stored billing strategy;
instantiating meter data structures as directed by the read billing strategy;
monitoring a document processing procedure as directed by the read billing strategy; and
updating the meter data structures as directed by the read billing strategy.
